(19) United States
(12) Patent Application Publication
(10) Pub. No.: US 2005/0243871 A1
(43) Pub. Date: Nov. 3, 2005

(54) Communication deivce and communication method

(75) Inventor: Yoshifumi Tanimoto, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/108,874

(22) Filed: Apr. 19, 2005

(30) Foreign Application Priority Data
Apr. 20, 2004 (JP) 2004-124495
Apr. 20, 2004 (JP) 2004-124636

(51) Int. Cl. H04L 12/28

(52) U.S. Cl. 370/522

(57) ABSTRACT

A communication device having a unit which carries out a data communication by a call control protocol, the communication device which can improve a communication efficiency of the data communication. The communication device acquires various pieces of information of a destination device in an initiation call control session by the call control protocol and selects a data communication method in accordance with a type of the data of the data communication and various pieces of information of the destination device.

### BACKGROUND OF THE INVENTION

1. Field of the Invention

The present invention relates to a communication device and a program which carry out a communication of various data such as voice data, moving image data, image data and text data in a media session established by a call control protocol such as a Session Initiation Protocol (SIP).

2. Description of Related Art

A recent widespread communication device transmits and receives various data, such as an IP telephone communication and an IP facsimile communication, through an Internet Protocol (IP) network. A proposal is made on a Multi Function Peripheral (MFP), which carries out a data communication supporting both voice data and image data. For example, a known communication device includes an IP telephone communication function and an IP facsimile communication function based on the International Telecommunication Union-Telecommunications (ITU-T) Recommendation T.38. Such a known communication device can transmit and receive image data at the same time by the IP telephone communication and the IP facsimile communication.

In such a communication device, when carrying out the IP telephone communication or the like, a call control protocol executes a function corresponding to an exchanger of a general public network such as a calling of a communication device of a destination and a management of a connection. H.323, the SIP or the like is used for the call control protocol in many cases. In particular, since the SIP just establishes, changes and ends a session and is not involved in the content of the session, the SIP is not limited to the IP telephone communication or the like. Various types of communication protocols such as the Simple Mail Transfer Protocol (SMTP) and the Hyper Text Transfer Protocol (HTTP) can be used in a media session established between a transmitter and recipient. That is, according to the SIP, various types of data such as voice data, moving image data and image data can be transmitted and received in the established media session. In addition, a plurality of media sessions can be established at the same time and a plurality of types of data communication can be carried out at the same time.

In the media session established by the SIP, there is a case in which the User Datagram Protocol (UDP) is used as a lower transport layer instead of the Transmission Control Protocol (TCP) having an error correction function. In such a case, the data communication is carried out with a communication destination without executing an error correction processing. In case of transmitting and receiving voice data, when a failure generates in a packet due to noise or the like, a part of the words of a speaker may be lost. However, a listener can understand the meaning and the content of the words of the speaker from the front and the back of the lost part. Therefore, in case the media session is used for a conversation, for example, in case of the IP telephone, there are only few cases when the failure causes a problem. However, in case of transmitting and receiving image data or text data, when a failure generates in a packet, the recipient fails to reproduce the original image data or the original text data from the received data. In case the TCP is used as a lower transport layer of the media session, the error correction function can be activated. However, the IP telephone communication or the like, which requires a real-time data transmission, cannot be carried out smoothly.

In case of carrying out the data communication in the media session established by the SIP, unlike the case in which the data communication is carried out directly on a TCP connection, various limitations are posed on the data transmission. As a result, the data communication cannot be carried out by using a band sufficiently. However, a conventional SIP-compatible communication device, which carries out a data communication with a destination designated by an IP telephone number, carries out the data communication in the media session at all times regardless of the type of the communication data (for example, voice data, moving image data, still image data and text data). Therefore, compared with an IP communication device that carries out a transmission processing of the still image data, the text data or the like directly on the TCP connection, the conventional SIP-compatible communication device requires a longer period of time for a data transfer.

### SUMMARY OF THE INVENTION

The present invention has been made in consideration of the above-described circumstances. An advantage of the present invention is to provide a communication device having a unit which carries out a data communication by a call control protocol, the communication device which can improve a communication efficiency of a data communication. Another advantage of the present invention is to provide a communication device which can set validity or invalidity of an error correction function according to a type of the communication data.

According to an aspect of the communication device, a communication device includes a unit which carries out a data communication with a destination in a media session established by a call control protocol. The communication device also includes a determination unit and a data communication unit. The determination unit determines whether or not to execute an error correction processing for the data communication to be carried out with the destination in accordance with information relating to a media session to be established. In case the determination unit determines to execute the error correction processing, the data communication unit carries out the data communication while executing the error correction processing. In case the determination unit determines not to execute the error correction processing, the data communication unit carries out the data communication without executing the error correction processing.

The information relating to the media session to be established includes, for example, various pieces of information acquired in a call control session formed prior to an establishment of the media session (for example, type information of communication data, a communication protocol, a destination IP address and a destination port number to be used in the media session) and various pieces of information decided by forming the call control session (for example, the type information of the communication data, the communication protocol, the destination IP address and the destination port number to be used in the media session).

According to another aspect of the present invention, the communication device includes a unit which carries out a data communication with a destination in a media session established by a call control protocol. The communication device also includes a unit which sets validity or invalidity of an error correction function for each type of the data transmitted and received in the media session.

According to another aspect of the present invention, the communication device includes an information acquiring unit and a data communication unit. The information acquiring unit acquires various pieces of information of the destination in an initiation call control session by the call control protocol. The data communication unit designates location information included in the acquired various pieces of information, establishes a TCP connection with the destination and carries out a data communication on the established TCP connection.

According to another aspect of the present invention, the communication device includes a first communication unit, a call control unit, a second communication unit and a data communication unit. The first communication unit carries out the data communication with the destination in the media session established by the call control protocol. The call control unit acquires various pieces of information of the destination in the initiation call control session by the call control protocol and executes a termination call control session without carrying out the data communication. The second communication unit designates location information included in the acquired various pieces of information of the destination, establishes a TCP connection with the destination and carries out the data communication over the established TCP connection. When starting the data communication, the data communication unit selects one of the first communication unit and the second communication unit in accordance with prescribed information and carries out the data communication by the selected communication unit.

The prescribed information includes, for example, various pieces of information acquired in the initiation call control session formed prior to the establishment of the media session (for example, the type information of the communication data, the communication protocol, the destination IP address and the destination port number to be used in the media session) and various pieces of information decided to be used in the media session to be established by forming the initiation call control session (for example, the type information of the communication data, the communication protocol, the destination IP address and the destination port number to be used in the media session). Alternatively, the communication device includes a registration unit which previously registers one of the first communication unit and the second communication unit as a communication unit to be used in device setting information or the like of the communication device, and the registered designation information can be used as the prescribed information.

According to this aspect of the present invention, the communication device determines whether or not to execute the error correction processing in accordance with the information relating to the media session to be established. In many cases, the type of the communication data transmitted and received in the media session can be specified by the information relating to the media session. Therefore, according to a characteristic of the data transmitted and received, for example, the communication device can carry out the error correction processing for image data or the like, which requires an error correction, and not carry out the error correction processing for voice communication data or the like, which an error correction should not be carried out.

The data communication efficiency can be improved for data, which the data communication can be carried out on the TCP connection, such as still image data and text data.

Moreover, the location information of the destination is acquired in the initiation call control session and the TCP connection is established by designating the acquired location information. Therefore, just by designating the IP telephone number of the destination, the user of the transmitter can carry out a data transmission to the destination. A designation operation of an e-mail address or a Uniform Resource Identifier (URI) of the destination can be omitted.

As the communication unit for carrying out the data communication, either one of the first communication unit and the second communication unit is selected in accordance with prescribed information. Therefore, the data communication can be carried out by using an appropriate communication unit according to the type of the communication data. Moreover, the error correction processing of the communication data is executed on the TCP connection. Therefore, for the type of the data communication that requires a reproduction of the original image data or the original text data from the data received at the recipient, the data communication is carried out directly on the TCP connection. For the type of the data communication that is preferable to be carried out in the media session, the data communication can be carried out in the media session.

### BRIEF DESCRIPTION OF THE SEVERAL VIEWS OF THE DRAWINGS

FIG. 1 shows an example of a configuration of a facsimile MFP (a communication device) according to a first embodiment of the present invention.

FIG. 2 shows an example of an error correction necessity determination table.

FIG. 3 shows an example of a session formed between facsimile MFPs (communication devices) when carrying out a data communication by the SIP between the facsimile MFPs according to the first embodiment of the present invention.

FIG. 4 is a flowchart showing a processing operation executed by a transmitter (communication device).

FIG. 5 is a flowchart showing a processing operation executed by a recipient (communication device).

FIG. 6 shows another example of an error correction necessity determination table.

FIG. 7 shows another example of an error correction necessity determination table.

FIG. 8 shows an example of a configuration of a facsimile MFP (a communication device) according to a second embodiment of the present invention.

FIG. 9 shows an example of a communication method determination table.

FIG. 10 shows an example of a session formed between facsimile MFPs (communication devices) when carrying out a data communication by the SIP between the facsimile MFPs according to the second embodiment of the present invention.

FIG. 11 shows an example of a session formed between the facsimile MFPs (communication devices) when carrying out a data communication directly on a TCP connection after forming a call control session by the SIP between the facsimile MFPs according to the second embodiment of the present invention.

FIG. 12 is a flowchart showing a processing operation executed by a transmitter (communication device).

FIG. 13 is a flowchart showing a transmission processing operation executed by the transmitter (communication device).

FIG. 14 is a flowchart showing a reception processing operation executed by a recipient (communication device).

FIG. 15 is a flowchart showing a reception processing operation executed by the recipient (communication device).

FIG. 16 shows another example of a communication method determination table.

FIG. 17 shows another example of a communication method determination table.

### DETAILED DESCRIPTION OF THE INVENTION

### First Embodiment

As a communication device according to an embodiment of the present invention, a description will be made of an example of a facsimile MFP having a G3 facsimile communication function, an Internet facsimile communication function or the like. Other than the facsimile MFP, the present invention can also be applied to another type of a communication device if the communication device can carry out various data communications with a destination in a media session established by a call control protocol.

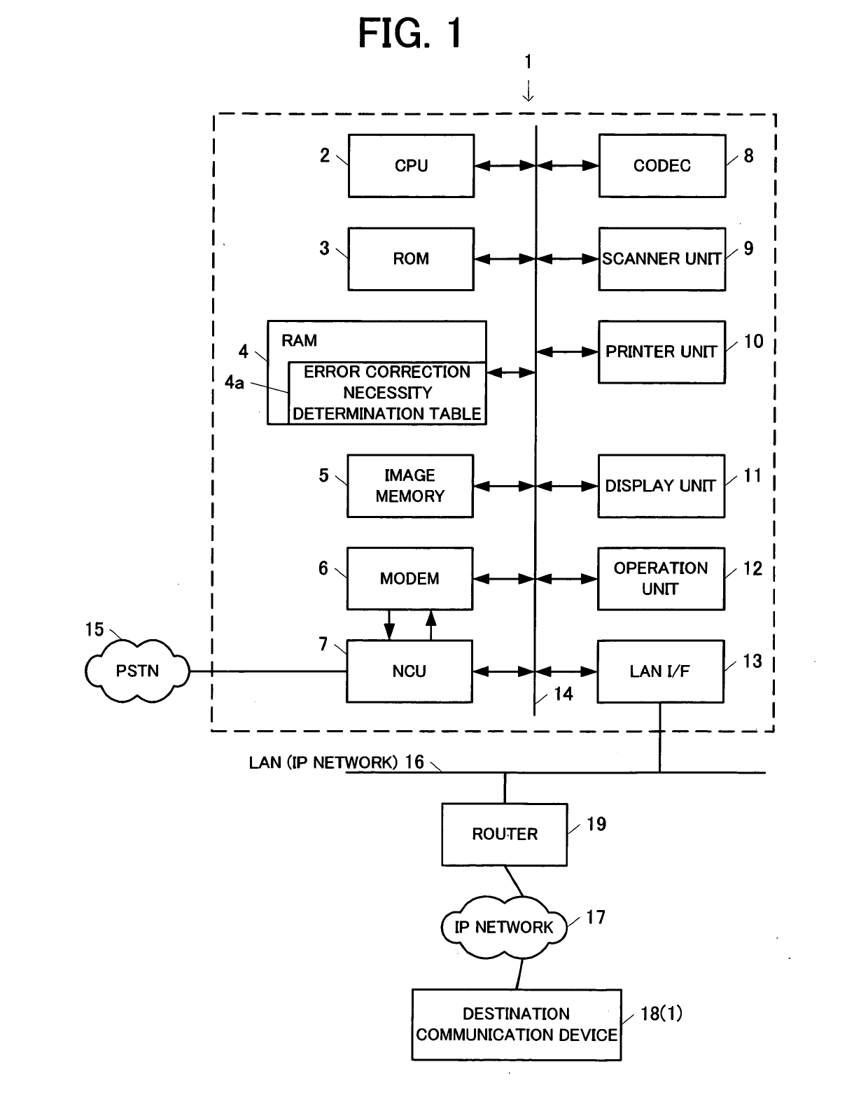

FIG. 1 shows an example of a configuration of a facsimile MFP 1. That is, the facsimile MFP 1 includes a Central Processing Unit (CPU) 2, a Read Only Memory (ROM) 3, a Random Access Memory (RAM) 4, an image memory 5, a modem 6, a Network Control Unit (NCU) 7, a codec 8, a scanner unit 9, a printer unit 10, a display unit 11, an operation unit 12 and a Local Area Network (LAN) interface 13. Each of the units 2 to 13 is connected via a bus 14.

The CPU 2 functions as a control unit which controls each of the units of the facsimile MFP 1 in accordance with a control program stored in the ROM 3. The ROM 3 stores the control program or the like. The RAM 4 functions as a main memory and a working area or the like of the CPU 2. The RAM 4 stores an error correction necessity determination table 4a.

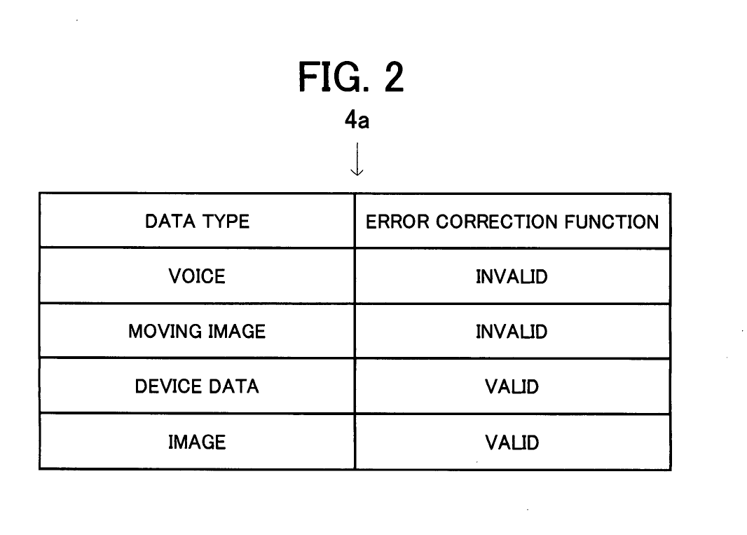

As shown in FIG. 2, the error correction necessity determination table 4a stores setting information regarding whether or not to execute an error correction processing for each type of data transmitted and received in a media session, in other words, for each type of a substantial content of the data such as a voice, a moving image, device data (of the communication device) and an image (a still image). That is, in the error correction necessity determination table 4a, validity or invalidity of the error correction function is set for each type of the data transmitted and received in the media session.

The image memory 5 stores image data or the like compressed and encoded by the codec 8. The modem 6 modulates and demodulates transmission data and received data in accordance with, for example, the IUT-T Recommendation V.34 standard or anything similar to this. The NCU 7 is a communication network control device which carries out an operation to close and release a communication line with a Public Switched Telephone Network (PSTN) 15. According to necessity, the NCU 7 connects the modem 6 with the PSTN 15. The codec 8 compresses and encodes image data for a facsimile transmission or the like in accordance with the Joint Photographic Experts Group (JPEG) method or the Modified Huffman (MH), the Modified Read (MR) or the Modified MR (MMR) method or the like. The codec 8 also decodes received image data or the like.

The scanner unit 9 scans image data of an original document. For example, the scanner unit 9 includes a Charge Coupled Device (CCD) color line sensor, an Analog-to-Digital (A/D) converter and an image processing circuit or the like. The printer unit 10 takes out printing paper from a paper feed cassette and prints received image data, scanned image data or the like onto the printing paper. The display unit 11 is configured from, for example, a Liquid Crystal Display (LCD) provided next to the operation unit 12, and displays various pieces of screen information. The operation unit 12 includes various operation keys or the like. A user performs various operations from the operation unit 7.

The LAN interface 13 is an interface for establishing a connection between the facsimile MFP 1 and a LAN 16. The facsimile MFP 1 carries out a communication through the LAN interface 13 with a client Personal Computer (PC) (not shown) and a router 19, which are also connected to the LAN 16. The facsimile MFP 1 also carries out various data communications through the router 19 with another SIP-compliant communication device 18 on an IP network 17.

The above-described facsimile MFP 1 is embedded with the UDP/IP, the TCP/IP, the SIP, the Real-time Transport Protocol (RTP), the Real-time Streaming Protocol (RTSP), the Session Description Protocol (SDP), the SMTP, the HTTP or the like. Accordingly, various data such as voice data, moving image data, image data (still image data) and text data can be transmitted and received in the media session established by a call control of the SIP.

Furthermore, the facsimile MFP 1 is embedded with a unique error correction protocol which operates in a protocol layer higher than the SIP, the RTP or the like and lower than a communication protocol which transmits and receives image data or text data. Therefore, an error correction processing executed by the unique error correction protocol is not involved in a communication protocol used in the media session and the content of the data exchanged by the communication protocol. Therefore, the error correction processing has an advantage that the communication protocol used in the media session is not limited to a specific protocol.

The unique error correction protocol forms, for example, a following protocol between a transmitter and a recipient. That is, in case the transmitter transmits data to the recipient in the media session established by the SIP, the transmitter divides the data into certain units and adds sequence numbers to divided blocks. The transmitter adds a total value (a checksum), which adds all of the data in a block together, to a prescribed place in the block, for example, at the end of the block. The recipient divides the received data in the same manner as described above. The recipient calculates a total value, which adds all of the data in a block together, and compares the total value with the value added to the prescribed place in the block. In case the values correspond with one another, the recipient determines that the data in the block does not have a defect. In case the values do not correspond with one another, the recipient determines that the data in the block has a defect and carries out a retransmission request of the data to the transmitter for such a block. Then, in accordance with the sequence numbers, the recipient restructures the data already received without any defect and the data retransmitted from the transmitter according to the retransmission request. A hush value may be used in place of the checksum.

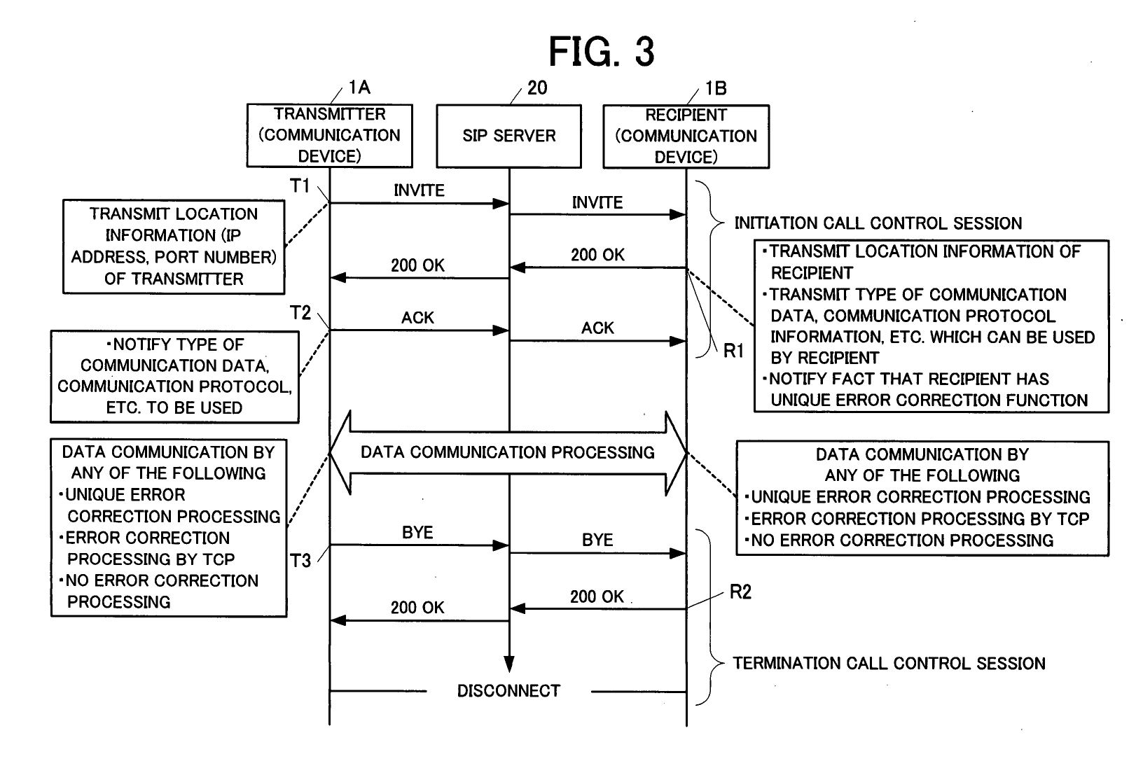

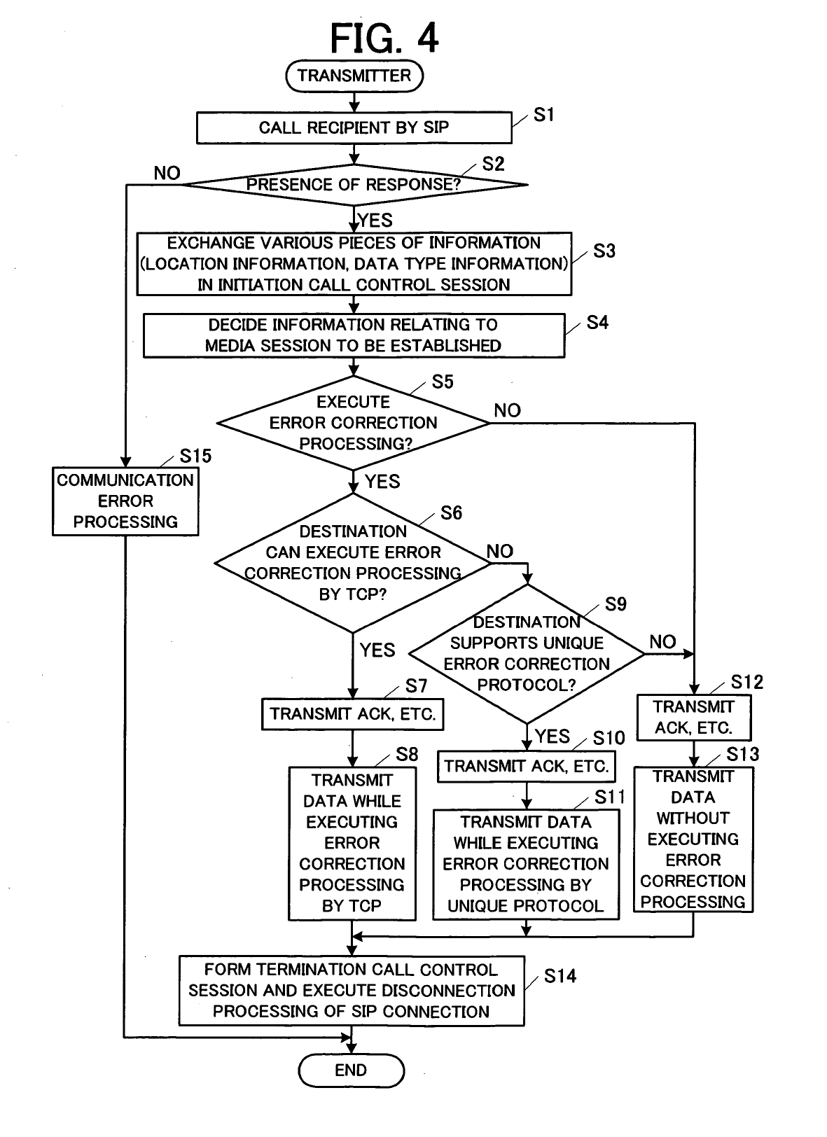

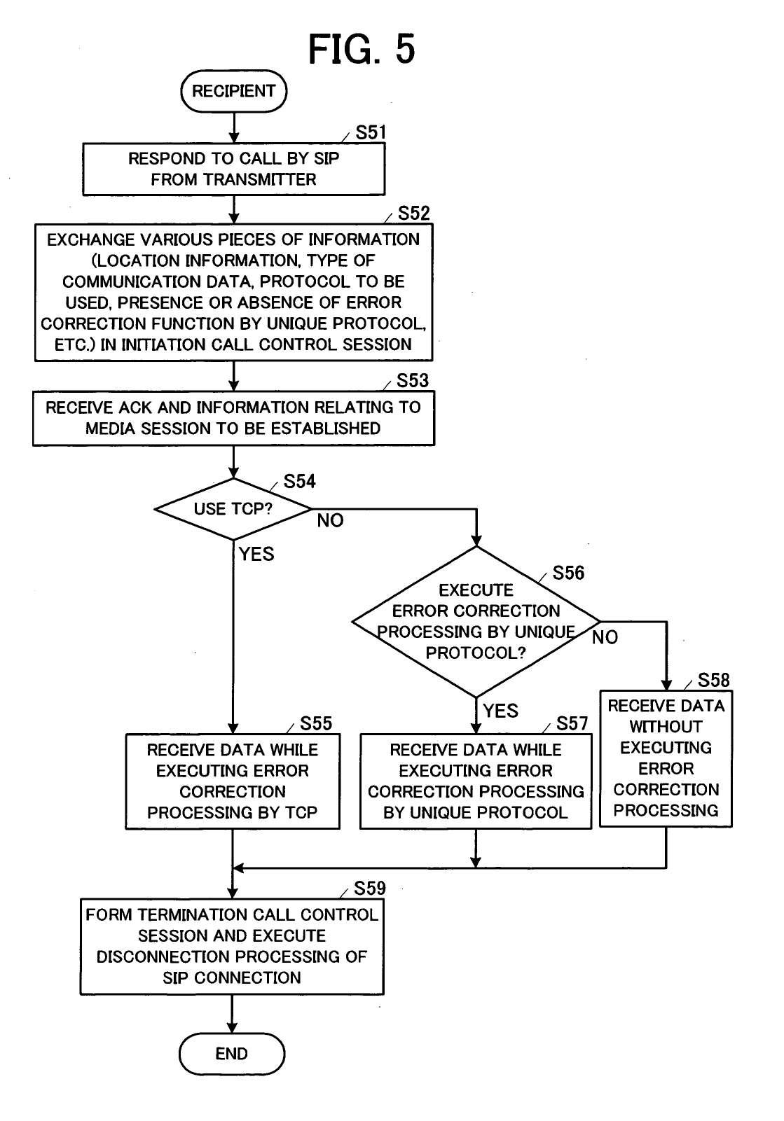

Next, referring to the sequence diagram of FIG. 3 and the flowcharts of FIG. 4 and FIG. 5, a description will be made of a processing operation carried out when the facsimile MFP 1 having the above-described configuration and function establishes a media session by the SIP (a call control protocol) with another facsimile MFP 1 having the same configuration and the same function as the facsimile MFP 1 and carries out a data communication. Further, the processing operation to be described with reference to FIG. 3 through FIG. 5 is carried out in accordance with a command generated by the CPU 2, which is a control unit, based on the control program stored in the ROM 3. For convenience of the description, the facsimile MFP 1 to be a transmitter will be referred to as a transmitter 1A and the facsimile MFP 1 to be a recipient will be referred to as a recipient 1B.

As shown in the sequence diagram of FIG. 3, first, a call control session is formed between the transmitter 1A and the recipient 1B by the SIP (hereinafter, this call control session will be referred to as an “initiation call control session”). That is, the transmitter 1A requests a SIP server 20, a call of the recipient 1B by a session participation request “INVITE”, which designates an IP telephone number of the recipient 1B. In addition, the transmitter 1A transmits to the recipient 1B, information such as an IP address and a port number to be used in the media session, as various pieces of information of the transmitter 1A (T1).

The SIP server 20, which received the information such as “INVITE”, inquires a location server (not shown), which has information that associates an IP telephone number and an IP address, as to an IP address associated with the IP telephone number designated by the transmitter 1A. The SIP server 20 carries out a call by transmitting the information such as “INVITE” received from the transmitter 1A to the acquired IP address of the recipient 1B.

When the recipient 1B responds to the call from the SIP server 20, the recipient 1B receives “INVITE” and various pieces of information such as the location information of the transmitter 1A. Then, the recipient 1B transmits a success response code “200 OK” to the SIP server 20. Along with the success response code “200 OK”, as various pieces of information relating to the recipient 1B, for example, the recipient 1B transmits an IP address which is the location information of the recipient 1B, a port number to be used in the media session, type information of communication data or a communication protocol which can be used by the recipient 1B and information indicating whether or not the recipient 1B supports the error correction function by the unique protocol (R1)

The transmitter 1A, which received the success response code “200 OK” and the various pieces of information of the recipient 1B, transmits information “ACK” which indicates a reception of the success response code “200 OK”. In addition, as information decided for the media session to be established, the transmitter 1A transmits to the recipient 1B via the SIP server 20, information such as a type of the communication data, a communication protocol and a port number to be used in the media session (T2). Then, a media session is established between the transmitter 1A and the recipient 1B and various data communications are executed according to the type of the communication data, the communication protocol, the communication port or the like decided by a negotiation carried out in the above-described initiation call control session.

After the data communication in the media session ends, the transmitter 1A transmits to the SIP server 20, “BYE” which requests a disconnection of the SIP connection. The SIP server 20, which received “BYE”, transmits “BYE” to the recipient 1B (T3). Then, when the recipient 1B transmits a success response code “200 OK” to the SIP server 20 (R2) and the SIP server 20 also transmits the success response code “200 OK” to the transmitter 1A, a series of session ends and the communication is disconnected. Further, the call control session formed after the end of the media session until the communication is disconnected will be referred to as a “termination call control session”.

Next, referring to the flowchart of FIG. 4, a description will be made of a processing operation or the like carried out by the transmitter 1A for determining whether or not to execute an error correction processing for the data communication carried out in the established media session.

The transmitter 1A calls the recipient 1B by the SIP at T1 (S1). In case of a presence of the response of R1 (S2: YES), the transmitter 1A exchanges the various pieces of information, in other words, carries out a negotiation necessary for establishing a media session, while forming an initiation call control session with the recipient 1B (S3). The transmitter 1A decides information relating to the media session such as the type of the data communication, the communication protocol and the communication port to be used in the media session (S4). Then, the transmitter 1A determines whether or not to execute an error correction processing of the data communication transmitted and received in the media session in accordance with the type information of the data communication among the decided information relating to the media session (S5).

That is, the transmitter 1A determines whether or not to execute the error correction processing in accordance with a setting of the error correction necessity determination table 4a associated with the type of the data communication to be carried out in the media session. Specifically, as shown in FIG. 2, in case the type of the data communication decided at S4 is a voice or a moving image, since the error correction function is set invalid, the transmitter 1A determines not to execute the error correction processing. In case the type of the data communication decided at S4 is device data or an image, since the error correction function is set valid, the transmitter 1A determines to execute the error correction processing (S5).

In case the transmitter 1A determines to execute the error correction processing (S5: YES), in case the transmitter 1A determines that the recipient 1B can execute the error correction processing using the TCP based on the various pieces of information of the recipient 1B acquired in the initiation call control session (S6: YES), the transmitter 1A transmits “ACK”, etc. to the recipient 1B (S7). The transmitter 1A carries out a data transmission to the recipient 1B while executing the error correction processing by the TCP in the established media session (S8).

In case the transmitter 1A determines at S6 that the recipient 1B cannot execute the error correction processing by using the TCP (S6: NO), the transmitter 1A determines whether or not the recipient 1B supports the error correction processing by the unique protocol based on the various pieces of information of the recipient 1B acquired in the initiation call control session (S9). In case the recipient 1B supports the error correction processing by the unique protocol (S9: YES), the transmitter 1A transmits “ACK”, etc. to the recipient 1B (S10). The transmitter 1A carries out a data transmission to the recipient 1B while executing the error correction processing by the unique protocol in the established media session (S11).

Meanwhile, in case the transmitter 1A determines at S5 not to execute the error correction processing (S5: NO), and in case the transmitter 1A determines at S9 that the recipient 1B does not support the error correction processing by the unique protocol (S9: NO), the transmitter 1A transmits “ACK”, etc. to the recipient 1B (S12). Then, the transmitter 1A carries out a data transmission to the recipient 1B without executing the error correction processing (S13). Further, at S12, the transmitter 1A can transmit information indicating that the error correction processing will not be executed.

Lastly, a termination call control session is formed between the transmitter 1A and the recipient 1B and a disconnection processing of the SIP connection is carried out (S14). Further, in case of the absence of the response from the recipient 1B at S2, in other words, in case the transmitter 1A receives a response code indicating an error content without receiving the success response code “200 OK” of R2, the transmitter 1A executes the communication error processing (S15). As the communication error processing, for example, a message, an error code or the like indicating a reason of the communication error is displayed on the display unit 11 or printed out from the printer unit 10.

Next, referring to the flowchart of FIG. 5, a description will be made of a processing operation of the recipient 1B, which is another party of the communication of the transmitter 1A.

When the recipient 1B responds to the call by the SIP from the transmitter 1A at T1 (S51), the recipient 1B exchanges various pieces of information, in other words, executes a negotiation necessary for establishing a media session, while forming the initiation call control session with the transmitter 1A (S52). The recipient 1B receives from the transmitter 1A, decided information relating to the media session to be established along with “ACK” (S53).

In case of using the TCP as the transport layer in the media session (S54: YES), the recipient 1B carries out a data reception in the established media session while executing the error correction processing by the TCP (S55).

In case of executing the error correction processing by the unique protocol (S54: NO, S56: YES), the recipient 1B carries out a data reception while executing the error correction processing by the unique protocol (S57). Further, in this case, the UDP is used as the transport layer.

In case of not executing the error correction processing (S54: NO, S56: NO), the recipient 1B carries out a data reception without executing the error corrosion processing (S58). Further, in this case, the UDP is used as the transport layer.

When the data reception processing of step S55, S57 or S58 is completed and the recipient 1B receives “BYE” from the transmitter 1A via the SIP server 20, the recipient 1B establishes a termination call control session with the transmitter 1A and carries out a disconnection processing of the SIP connection (S59).

As described above, according to the communication device of the first embodiment of the present invention, in case the type of the communication data transmitted and received in the media session is the voice data or the like that requires to be in real-time, the voice data or the like is transmitted and received without executing an error correction. In case of the communication data such as the text data and the image data that requires a complete reproduction of the original data at the recipient, the image data or the like is transmitted and received while executing an error correction. Therefore, a multimedia communication can be carried out according to a characteristic, an object or the like of the communication data transmitted and received by using the SIP.

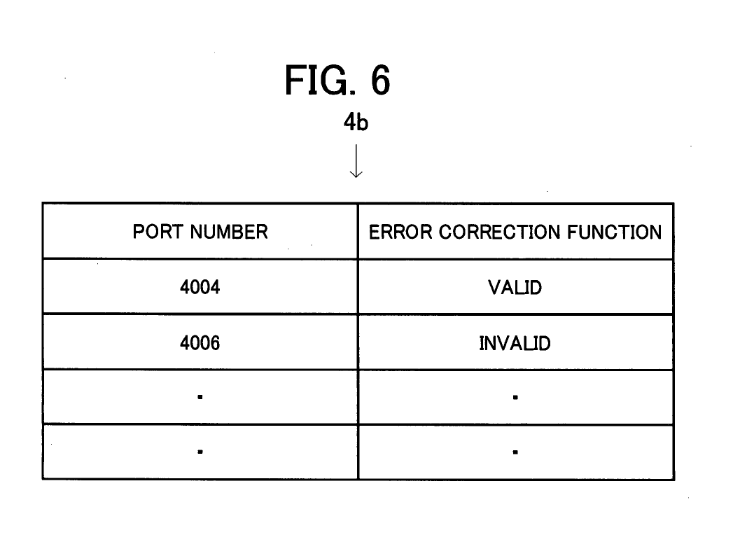

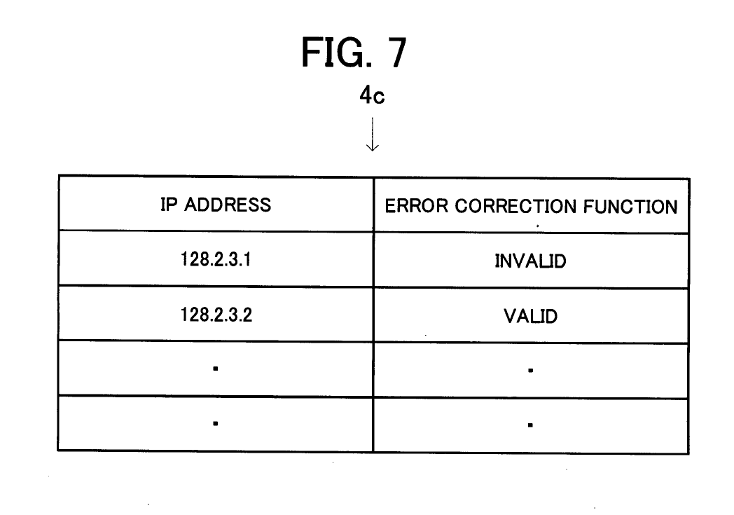

Next, another example of the first embodiment will be described. Instead of the error correction necessity determination table 4a, the facsimile MFP 1 of another example of the first embodiment includes an error correction necessity determination table shown in FIG. 6 or FIG. 7 and carries out the determination processing of S6 in accordance with this error correction necessity determination table.

An error correction necessity determination table 4b shown in FIG. 6 sets validity and invalidity of the error correction function for each destination port number. In the determination processing of S5, the transmitter 1A determines whether or not to execute the error correction processing in accordance with the setting of the error correction necessity determination table 4b associated with the destination port number among the information relating to the media session decided at S4. Specifically, as shown in FIG. 6, in case the destination port number decided at S4 is “4006”, since the error correction function is set invalid, the transmitter 1A determines not to execute the error correction processing. In case the destination port number decided at S4 is “4004”, since the error correction function is set valid, the transmitter 1A determines to execute the error correction processing.

An error correction necessity determination table 4c shown in FIG. 7 sets validity and invalidity of the error correction function for each destination IP address. In the determination processing of S5, the transmitter 1A determines whether or not to execute the error correction processing in accordance with the setting of the error correction necessity determination table 4c associated with the destination IP address among the information relating to the media session decided at S4. Specifically, as shown in FIG. 7, in case the destination IP address decided at S4 is “128.2.3.1”, since the error correction function is set invalid, the transmitter 1A determines not to execute the error correction processing. In case the destination IP address decided at S4 is “128.2.3.2”, since the error correction function is set valid, the transmitter 1A determines to execute the error correction processing.

To determine whether or not to execute the error correction processing, the above-described determination processing of S5 can be carried out in accordance with information relating to the media session other than the type of the communication data, the destination IP address and the destination port number described above.

In the above description, the facsimile MFPs 1 established a single media session. However, in case of establishing a plurality of media sessions at the same time and exchanging a plurality of types of communication data at the same time, the transmitter 1A and the recipient 1B execute the processing operation of S5 through S13 and S54 through S58 for each of the media sessions. Accordingly, even in case a plurality of media sessions are established, the error correction processing can be executed on only the communication data of a type that requires the error correction processing and the error correction processing can be not executed on the communication data of a type that does not require the error correction processing. Further, in case the recipient 1B has one IP address, the transmitter 1A is preferable to use the error correction necessity determination table 4a or 4b and not the error correction necessity determination table 4c for the determination processing of S5.

### Second Embodiment

As the communication device according to a second embodiment of the present invention, a description will be made of an example of a facsimile MFP having a G3 facsimile communication function, an Internet facsimile communication function or the like. Other than the facsimile MFP, the present invention can also be applied to another type of a communication device if the communication device can carry out various data communications with a destination in a media session established by a call control protocol and on a TCP connection.

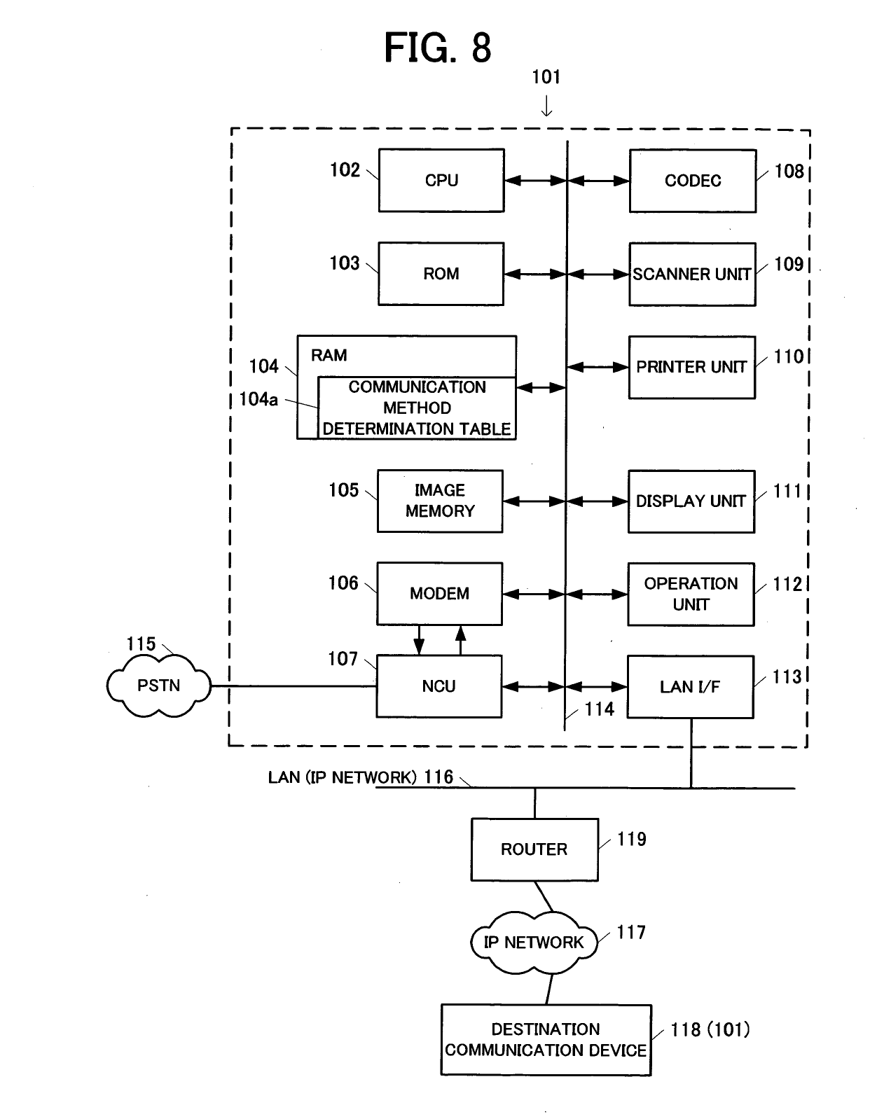

FIG. 8 shows an example of a configuration of a facsimile MFP 101. That is, the facsimile MFP 101 includes a CPU 102, a ROM 103, a RAM 104, an image memory 105, a modem 106, a NCU 107, a codec 108, a scanner unit 109, a printer unit 110, a display unit 111, an operation unit 112 and a LAN interface 113. Each of the units 102 to 113 is connected via a bus 114.

The CPU 102 functions as a control unit which controls each of the units of the facsimile MFP 101 in accordance with a control program stored in the ROM 103. The ROM 103 stores the control program or the like. The RAM 104 functions as a main memory and a working area or the like of the CPU 102. The RAM 104 stores a communication method determination table 104a.

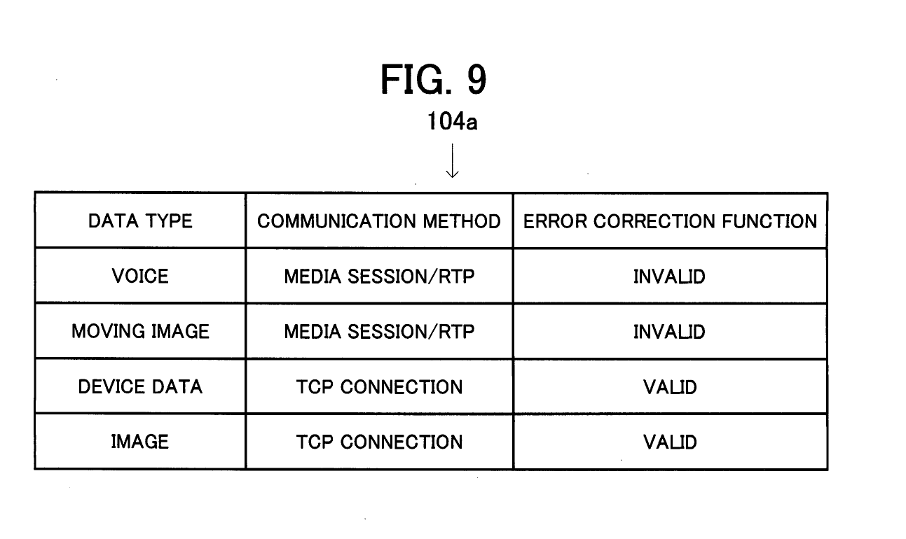

As shown in FIG. 9, the communication method determination table 104a stores setting information regarding whether to execute a data communication in a media session or whether to carry out a data communication directly over the TCP connection and not in the media session, for each type of the communication data, in other words, for each type of a substantial content of the communication data such as a voice, a moving image, device data (of the communication device) and an image (a still image). The communication method determination table 104a also stores setting information regarding whether or not to execute an error correction processing for each type of the communication data.

The image memory 105 stores image data or the like compressed and encoded by the codec 108. The modem 106 modulates and demodulates transmission data and received data in accordance with, for example, the IUT-T Recommendation V.34 standard or anything similar to this. The NCU 107 is a communication network control device which carries out an operation to close and release a communication line with a PSTN 115. According to necessity, the NCU 107 connects the modem 106 with the PSTN 115. The codec 108 compresses and encodes image data for a facsimile transmission or the like in accordance with the JPEG method or the MH, the MR or the MMR method or the like. The codec 108 also decodes received image data or the like.

The scanner unit 109 scans image data of an original document. For example, the scanner unit 109 includes a CCD color line sensor, an A/D converter and an image processing circuit or the like. The printer unit 110 takes out printing paper from a paper feed cassette and prints received image data, scanned image data or the like onto the printing paper. The display unit 111 is configured from, for example, a LCD provided next to the operation unit 112, and displays various pieces of screen information. The operation unit 112 includes various operation keys or the like. A user performs various operations from the operation unit 107.

The LAN interface 113 is an interface for establishing a connection between the facsimile MFP 101 and a LAN 116. The facsimile MFP 101 carries out a communication through the LAN interface 113 with a client PC (not shown) and a router 119, which are also connected to the LAN 116. The facsimile MFP 101 also carries out various data communications through the router 119 with another SIP-compliant communication device 118 on an IP network 117.

The above-described facsimile MFP 101 is embedded with the UDP/IP, the TCP/IP, the SIP, the RTP, the RTSP, the SDP, the SMTP, the HTTP or the like. Accordingly, the image data (the still image data) and the text data or the like can be transmitted and received by the SMTP, the HTTP or the like, directly over the TCP connection. The voice data and the moving image data can be transmitted and received by the RTP or the like in the media session established by the call control of the SIP. The image data (the still image data) and the text data or the like can be transmitted and received by the SMTP, the HTTP or the like in the media session established by the call control of the SIP.

Furthermore, the facsimile MFP 101 is embedded with a unique error correction protocol which operates in a protocol layer higher than the SIP, the RTP or the like and lower than a communication protocol which transmits and receives image data or text data. Therefore, an error correction processing executed by the unique error correction protocol is not involved in a communication protocol used in the media session and the content of the data exchanged by the communication protocol. Therefore, the error correction processing has an advantage that the communication protocol used in the media session is not limited to a specific protocol.

The unique error correction protocol forms, for example, a following protocol between a transmitter and a recipient. That is, in case the transmitter transmits data to the recipient in the media session established by the SIP, the transmitter divides the data into certain units and adds sequence numbers to divided blocks. The transmitter adds a total value (a checksum), which adds all of the data in a block together, to a prescribed place in the block, for example, at the end of the block. The recipient divides the received data in the same manner as described above. The recipient calculates a total value, which adds all of the data in a block together, and compares the total value with the value added to the prescribed place in the block. In case the values correspond with one another, the recipient determines that the data in the block does not have a defect. In case the values do not correspond with one another, the recipient determines that the data in the block has a defect and carries out a retransmission request of the data to the transmitter for such a block. Then, in accordance with the sequence numbers, the recipient restructures the data already received without any defect and the data retransmitted from the transmitter according to the retransmission request. A hush value may be used in place of the checksum.

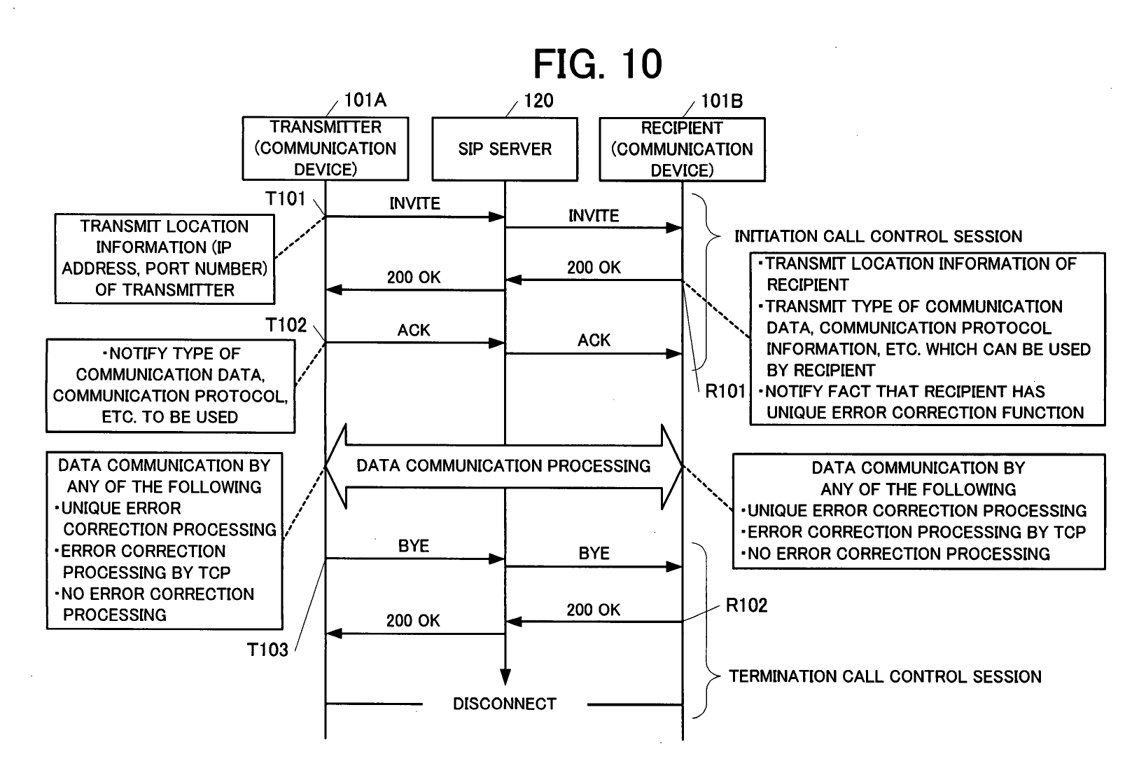

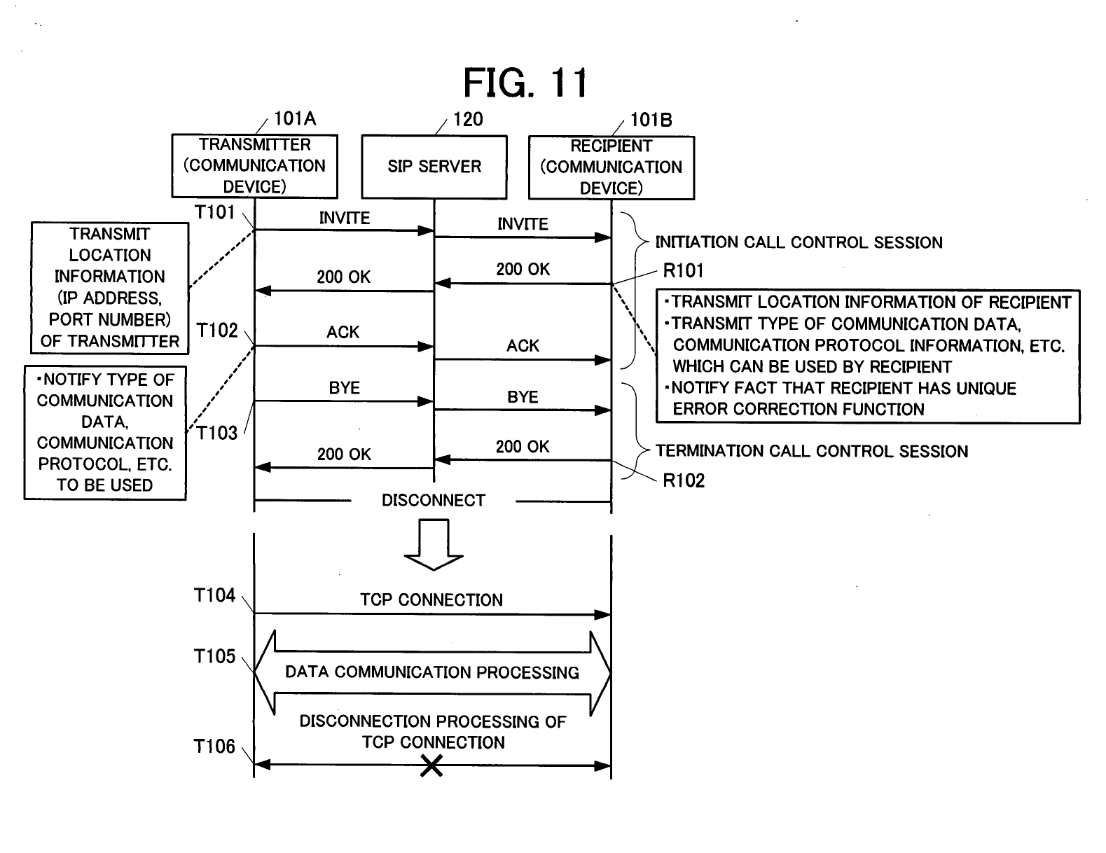

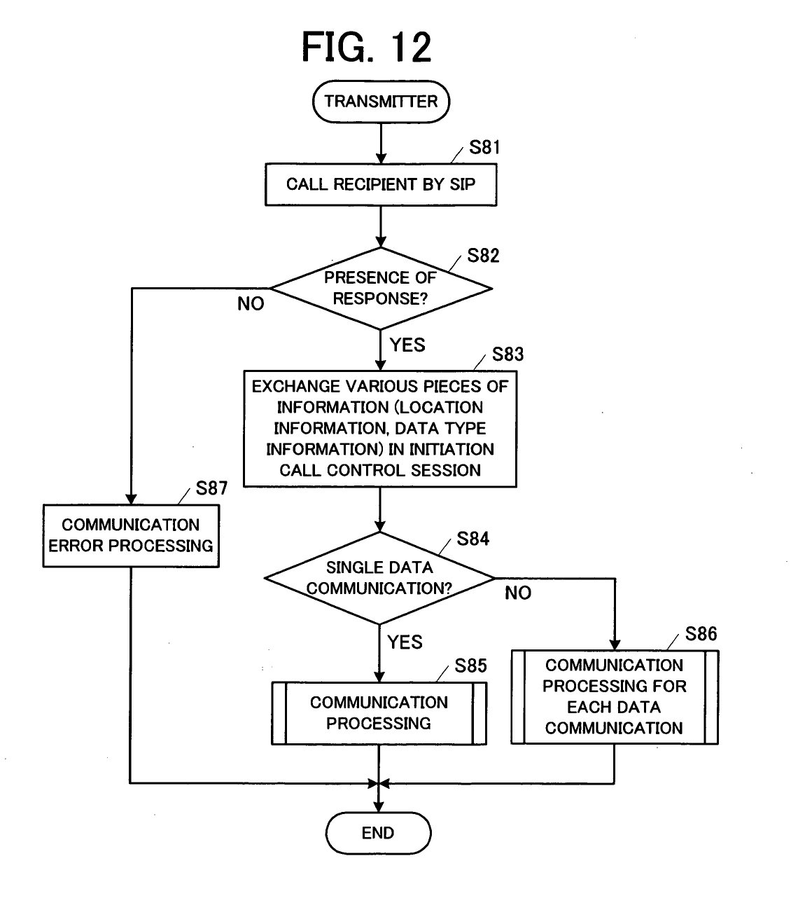

Next, referring to the sequence diagrams of FIG. 10 and FIG. 11 and the flowcharts of FIG. 12 through FIG. 15, a description will be made of a processing operation carried out when the facsimile MFP 101 having the above-described configuration and function carries out a data communication with another facsimile MFP 101 having the same configuration and the same function as the facsimile MFP 101. Further, the processing operation to be described with reference to FIG. 10 through FIG. 15 is carried out in accordance with a command generated by the CPU 102, which is a control unit, based on the control program stored in the ROM 103. For convenience of the description, the facsimile MFP 101 to be a transmitter will be referred to as a transmitter 101A and the facsimile MFP 101 to be a recipient will be referred to as a recipient 101B.

As shown in the sequence diagrams of FIG. 10 and FIG. 11, first, a call control session is formed between the transmitter 101A and the recipient 101B by the SIP. That is, the transmitter 101A requests a SIP server 120, a call of the recipient 101B by a session participation request “INVITE”, which designates an IP telephone number of the recipient 101B. In addition, the transmitter 101A transmits to the recipient 101B, information such as an IP address and a port number to be used in the media session, as various pieces of information of the transmitter 101A (T101). Further, in the second embodiment, the call control session formed before the media session is established will be referred to as an “initiation call control session”.

The SIP server 120, which received the information such as “INVITE”, inquires a location server (not shown), which has information that associates an IP telephone number and an IP address, as to an IP address associated with the IP telephone number designated by the transmitter 101A. The SIP server 120 carries out a call by transmitting the information such as “INVITE” received from the transmitter 101A to the acquired IP address of the recipient 101B.

When the recipient 101B responds to the call from the SIP server 120, the recipient 101B receives “INVITE” and various pieces of information such as the location information of the transmitter 101A. Then, the recipient 101B transmits a success response code “200 OK” to the SIP server 120. Along with the success response code “200 OK”, as various pieces of information relating to the recipient 101B, for example, the recipient 101B transmits an IP address which is the location information of the recipient 101B, a port number to be used, type information of communication data or a communication protocol which can be used by the recipient 101B and information indicating whether or not the recipient 101B supports the error correction function by the unique protocol (R101).

The transmitter 101A, which received the success response code “200 OK” and the various pieces of information of the recipient 101B, decides the type of the communication data or the like from the various pieces of information of the recipient 101B (for example, the communication protocol which can be used by the recipient 101B) and the communication protocol to be used by the transmitter 101A for the data transmission, or the like. Then, in accordance with the decided type of the communication data, the transmitter 101A selects whether to use a first communication unit or a second communication unit (a detail of the selection operation will be described later) and carries out a data communication by the selected communication unit. Further, the first communication unit carries out the data communication with a destination in the media session by the SIP. The second communication unit forms a termination call control session without carrying out the data communication in the media session, and then establishes a new TCP connection with the same destination and carries out the data communication directly over the established TCP connection. Further, information that designates either one of the communication units as the communication unit to be used can be registered previously in device setting information or the like of the transmitter 101A. Then, in accordance with the registered designation information, either one of the communication units can be selected.

In case the transmitter 101A selects to carry out the data communication with the destination in the media session, as shown in FIG. 10, the transmitter 101A transmits information “ACK” which indicates a reception of the success response code “200 OK”. In addition, as information decided for the media session to be established, the transmitter 101A transmits to the recipient 101B via the SIP server 120, information such as a type of the communication data, a communication protocol and a port number to be used in the media session (T102). Then, a media session is established between the transmitter 101A and the recipient 101B. The transmitter 101A carries out various data communications with the recipient 101B according to the type of the communication data, the communication protocol, the communication port or the like decided by the negotiation carried out in the above-described initiation call control session.

After the data communication in the media session ends, the transmitter 101A transmits to the SIP server 120, “BYE” which requests a disconnection of the SIP connection. The SIP server 120, which received “BYE”, transmits “BYE” to the recipient 101B (T103). Then, when the recipient 101B transmits a success response code “200 OK” to the SIP server 120 (R102) and the SIP server 120 also transmits the success response code “200 OK” to the transmitter 101A, a series of session ends and the communication is disconnected. Further, the call control session formed after the end of the media session until the communication is disconnected will be referred to as a “termination call control session”.

Meanwhile, after the transmitter 101A receives the success response code “200 OK” and the various pieces of information transmitted from the recipient 101B at R101, in case the transmitter 101A selects to carry out the data communication with the destination by establishing a new TCP connection without carrying out the data communication in the media session, as shown in FIG. 11, immediately after the transmitter 101A transmits the information at T102, the transmitter 101A transmits “BYE”, which requests a disconnection of the SIP connection, to the SIP server 120 and forms a termination call control session with the recipient 101B, and disconnects the SIP connection. Then, the transmitter 101A newly requests a TCP connection to the recipient 101B and establishes the TCP connection between the transmitter 101A and the recipient 101B (T104). The transmitter 101A carries out a data transmission to the recipient 101B directly over the established TCP connection (T105). After the data transmission processing is completed, a disconnection processing of the TCP connection is carried out (T106).

In the above description, the transmitter 101A carries out the data communication in the media session established by the SIP or directly over the TCP connection. However, in case of carrying out data communications by a plurality of types of communication protocols at the same time, a part of the data communications can be carried out in the media session (refer to FIG. 10) and other data communications can be carried out over the newly established TCP connection (refer to the lower part of FIG. 11).

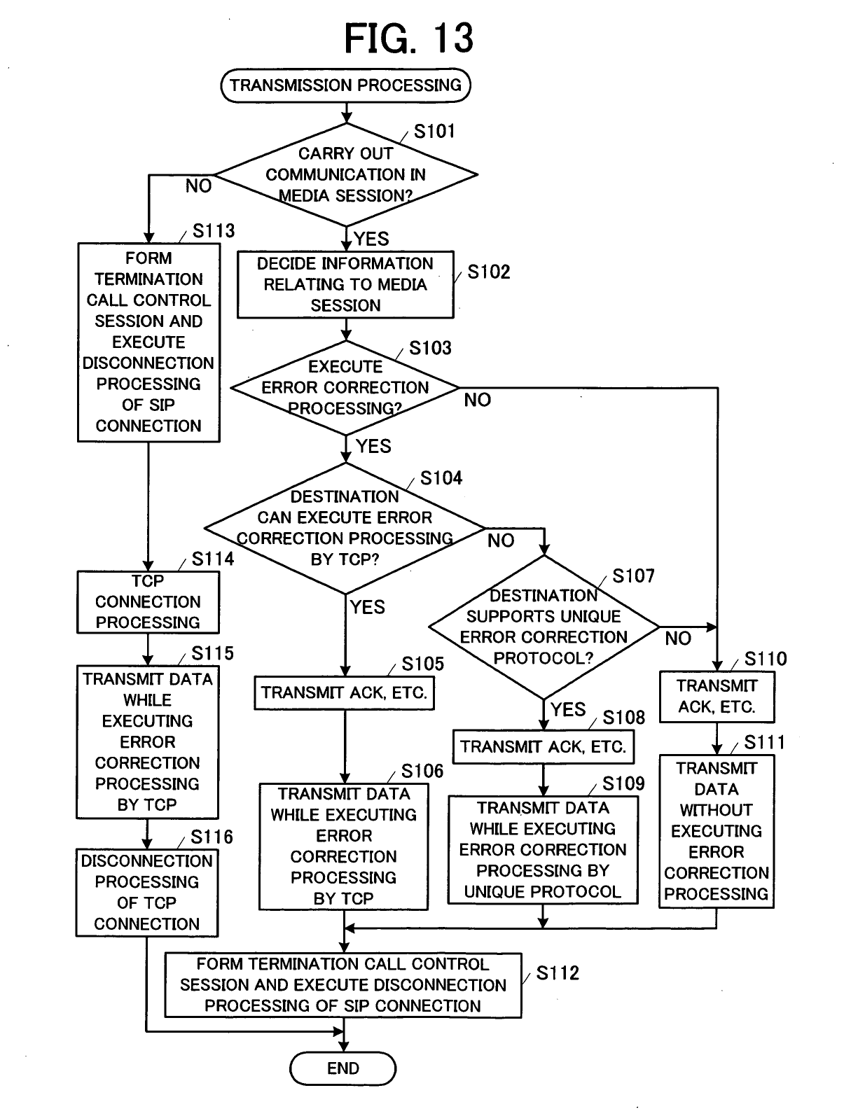

Next, referring to the flowcharts of FIG. 12 and FIG. 13, a description will be made of a processing operation or the like carried out by the transmitter 101A in case the transmitter 101A carries out the data communication by selecting whether to carry the data communication in the media session or whether to carry out the data communication directly over the TCP connection when carrying out the initiation call control session.

The transmitter 101A calls the recipient 101B by the SIP at T101 (S81). In case of a presence of the response of R101 (S82: YES), the transmitter 101A carries out a negotiation while forming an initiation call control session with the recipient 101B (S83). The transmitter 101A acquires the type of the communication, the communication protocol, the communication port or the like which can be used by the recipient 101B.

In case the transmitter 101A carries out the data communication with the recipient 101B by a single data communication (S84: YES), the transmitter 101A carries out a communication processing to be described later (S85). Meanwhile, in case the data communication between the transmitter 101A and the recipient 101B is carried out by a plurality of data communications, for example, in case of the voice data communication and the image data communication, or in case of the voice data communication and the moving image communication, the transmitter 101A carries out a communication processing to be described later for each data communication (S86).

Further, in case of an absence of the response from the recipient 101B at S82, in other words, in case the transmitter 101A receives a response code indicating an error content without receiving the success response code “200 OK” of R102, the transmitter 101A executes a communication error processing (S87). As the communication error processing, for example, a message, an error code or the like indicating a reason of the communication error is displayed on the display unit 111 or printed out from the printer unit 110.

Next, referring to the flowchart of FIG. 13, a description will be made of the communication processing of S85 and S86 of the transmitter 101A. Further, the content of the communication processing carried out at S85 and S86 differs in that at S85, the communication processing to be described later is carried out for one data communication and at S86, the communication processing to be described later is carried out for each of a plurality of data communications. The content of the communication processing carried out for each data communication is the same.

First, the transmitter 101A selects whether or not to carry out the data communication in the media session in accordance with a type of the data communication to be carried out (S101). That is, in accordance with the setting of the communication method determination table 104a associated with the type of the data communication to be carried out, the transmitter 101A selects whether to carry out the data communication in the media session or whether to carry out the data communication by ending the SIP connection and establishing a new TCP connection. For example, as shown in FIG. 9, in case the type of the data communication to be carried out is a voice or a moving image, since the communication method is set as “MEDIA SESSION/RTP”, the transmitter 101A selects to carry out the data communication in the media session. In case the type of the data communication to be carried out is device data or an image, the transmitter 101A selects to carry out the data communication by ending the SIP connection and establishing a new TCP connection (S101).

In case the transmitter 101A selects to carry out the data communication in the media session (S101: YES), the transmitter 101A decides information relating to the media session such as a type of the data communication, a communication protocol and a communication port or the like to be used in the media session (S102). Then, among the decided information relating to the media session, in accordance with the type information of the data communication, the transmitter 101A determines whether or not to execute an error correction processing of the data communication transmitted and received in the media session (S103). That is, in accordance with the setting of the communication method determination table 104a associated with the type of the data communication carried out in the media session, the transmitter 101A determines whether or not to execute the error correction processing. For example, as shown in FIG. 9, in case the type of the data communication to be carried out is a voice or a moving image, since the error correction function is set invalid, the transmitter 101A determines not to execute the error correction processing. In case the type of the data communication to be carried out is device data or an image, since the error correction function is set valid, the transmitter 101A determines to execute the error correction processing (S103).

In case the transmitter 101A determines to execute the error correction processing (S103: YES), in case the transmitter 101A determines that the recipient 101B can execute the error correction processing by using the TCP in accordance with the various pieces of information of the recipient 101B acquired in the initiation call control session (S104: YES), the transmitter 101A transmits “ACK”, etc. to the recipient 101B (S105). The transmitter 101A carries out a data transmission to the recipient 101B while executing the error correction processing by the TCP in the established media session (S106).

At S104, in case the transmitter 101A determines that the recipient 101B cannot execute the error correction processing by using the TCP (S104: NO), in accordance with the various pieces of information of the recipient 101B acquired in the initiation call control session, the transmitter 101A determines whether or not the recipient 101B supports the error correction processing by the unique protocol (S107). In case the recipient 101B supports the error correction processing by the unique protocol (S107: YES), the transmitter 101A transmits “ACK”, etc. to the recipient 101B (S108). The transmitter 101A carries out a data transmission to the recipient 101B while executing the error correction processing by the unique protocol in the established media session (S109).

Meanwhile, in case the transmitter 101A determines at S103 not to execute the error correction processing (S103: NO), and in case the transmitter 101A determines at S107 that the recipient 101B does not support the error correction processing by the unique protocol (S107: NO), the transmitter 101A transmits “ACK”, etc. to the recipient 101B (S110). The transmitter 101A carries out a data transmission to the recipient 101B without executing the error correction processing (S111). Further, at S110, the transmitter 101A can transmit information indicating that the error correction processing will not be executed.

The transmitter 101A forms a termination call control session with the recipient 101B and executes a disconnection processing of the SIP connection (S112).

Meanwhile, at S101, in case the transmitter 101A selects to end the SIP connection and to carry out the data communication by establishing a new TCP connection (S101: NO), the transmitter 101A immediately forms a termination call control session with the recipient 101B and executes a disconnection processing of the SIP connection (S113). Next, the transmitter 101A carries out a TCP connection processing that designates the location information (an IP address, a port number) of the recipient 101B acquired in the initiation call control session and establishes a TCP connection (S114). Then, the transmitter 101A carries out a data transmission to the recipient 101B directly on the TCP connection while executing the error correction processing by the TCP (S115). After the data transmission processing is completed, the transmitter 101A executes a disconnection processing of the TCP connection (S116).

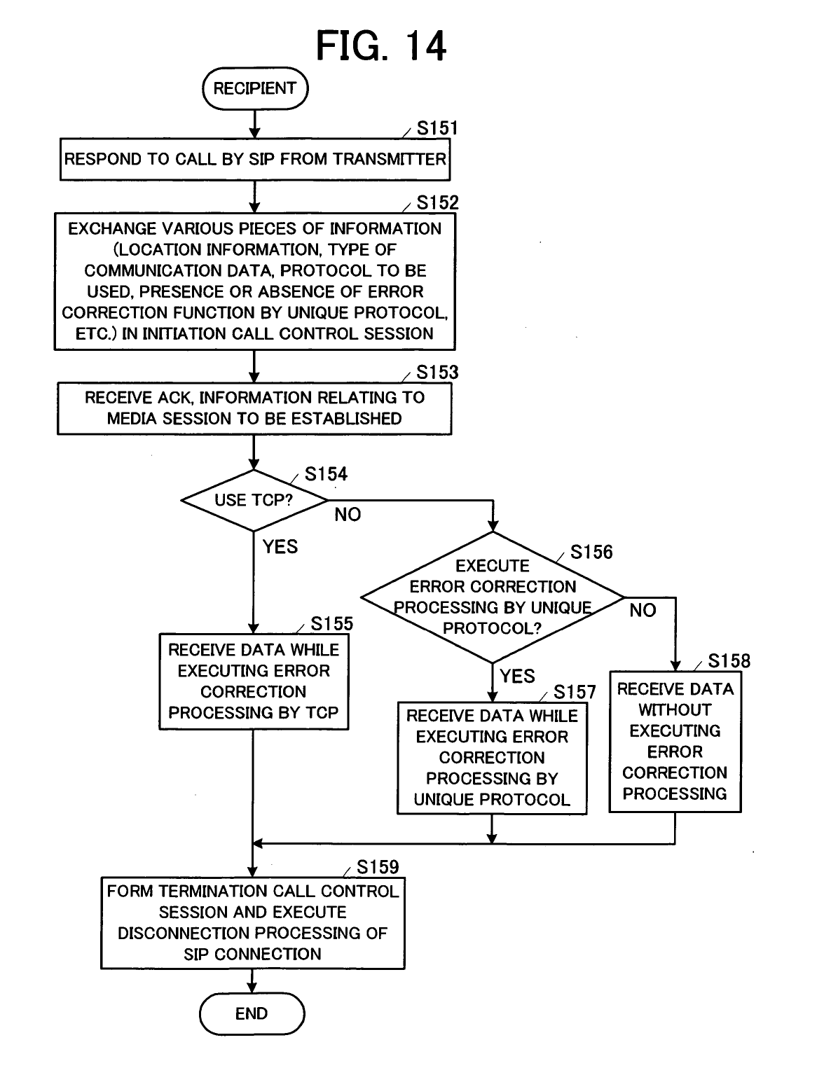

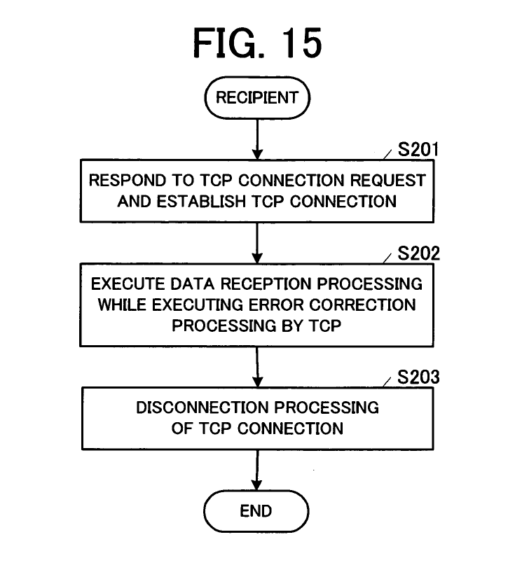

Next, referring to the flowcharts of FIG. 14 and FIG. 15, a description will be made of the processing operation of the recipient 101B, which is another party of the communication of the transmitter 101A.

The recipient 101B responds to a call by the SIP from the transmitter 101A at T101 (S151). Then, while forming an initiation call control session with the transmitter 101A, the recipient 101B exchanges the various pieces of information, in other words, carries out a negotiation necessary for establishing a media session (S152). The recipient 101B receives from the transmitter 101A, decided information relating to the media session to be established along with “ACK” (S153).

In case of using the TCP as a transport layer in the media session (S154: YES), the recipient 101B carries out a data reception while executing the error correction processing by the TCP in the established media session (S155).

In case of executing the error correction processing by the unique protocol (S154: NO, S156: YES), the recipient 101B carries out a data reception while executing the error correction processing by the unique protocol (S157). Further, in this case, the UDP is used as the transport layer.

In case of not executing the error correction processing (S154: NO, S156: NO), the recipient 101B carries out a data reception without executing the error correction processing (S158). Further, in this case, the UDP is used as the transport layer.

After the data reception processing of S155, S157 or S158 is completed and the recipient 101B receives “BYE” from the transmitter 101A via the SIP server 120, the recipient 101B forms a termination call control session with the transmitter 101A and executes a disconnection processing of the SIP connection (S159).

Meanwhile, in case the recipient 101B establishes a TCP connection with the transmitter 101A according to the request of the TCP connection at S114 from the transmitter 101A (S201), the recipient 101B carries out a data reception directly on the TCP connection while executing the error correction processing by the TCP (S202). After the data reception is completed, the recipient 101B executes a disconnection processing of the TCP connection (S203).

In case the transmitter 101A carries out a plurality of data communications with the recipient 101B, the transmission processing of the transmitter 101A (S101 through S116) and the reception processing of the recipient 101B (S151 through S159, S201 through S203) are carried out at the same time for each of the data communications. Therefore, for example, in case the transmitter 101A carries out the data communication for both the voice data and the still image data as the type of the data communication to be carried out with the recipient 101B, the media session for carrying out the voice data communication and the TCP connection for carrying out the still image data communication are established at the same time.

As described above, according to the facsimile MFP (communication device) 101 of the second embodiment of the present invention, in case the type of the communication data transmitted and received is the voice data or the like that requires to be in real-time, the data communication is carried out in the media session without executing the error correction processing. Incase of the communication data such as the image data that requires a complete reproduction of the original data at the recipient, the data communication can be carried out while executing the error correction processing in the media session, or while executing the error correction processing by disconnecting the SIP connection and establishing a new TCP connection. Therefore, according to the facsimile MFP 101, the data communication processing is carried out according to a characteristic, an object or the like of the communication data transmitted and received by using the SIP.

The transmitter 101A requests a TCP connection by using the location information of the recipient 101B acquired in the initiation call control session of the SIP. Therefore, an inquiry processing to a Domain Name System (DNS) or the like can be omitted. Furthermore, just by designating the IP telephone number of the destination, the user of the transmitter can carry out a data transmission to the destination. A designation operation of an e-mail address or a URI of the destination can be omitted.

In case of carrying out the data communication in the media session, various limitations are posed on the data communication and a band cannot be utilized sufficiently. However, if the data communication of the still image or the like is carried out directly on the TCP connection, the data communication can be carried out sufficiently efficiently.

Even in case of the communication data such as the image data that requires a complete reproduction of the original data at the recipient, the data communication can be carried out while executing the error correction processing by the TCP or the unique protocol in the media session established by the SIP according to the setting of the communication method determination table 104a.

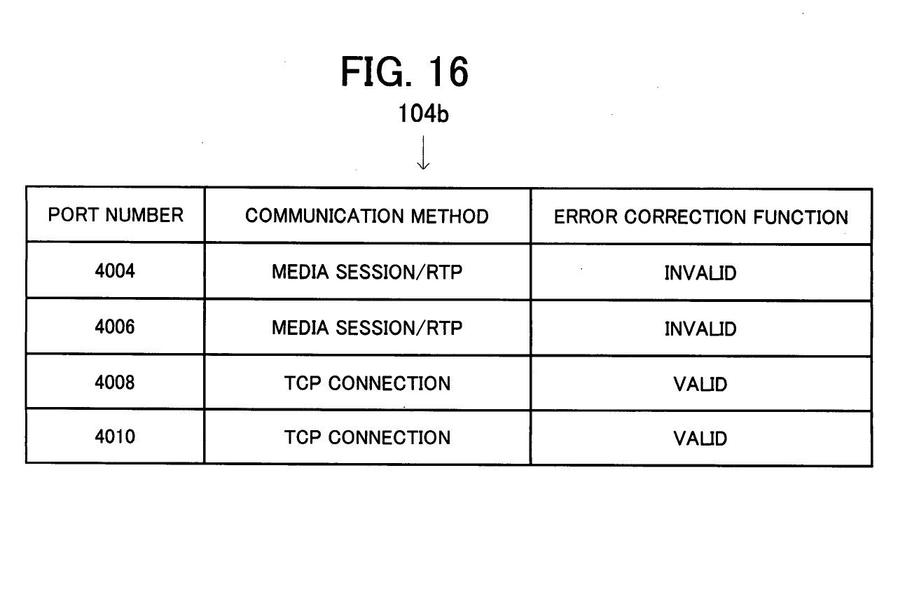

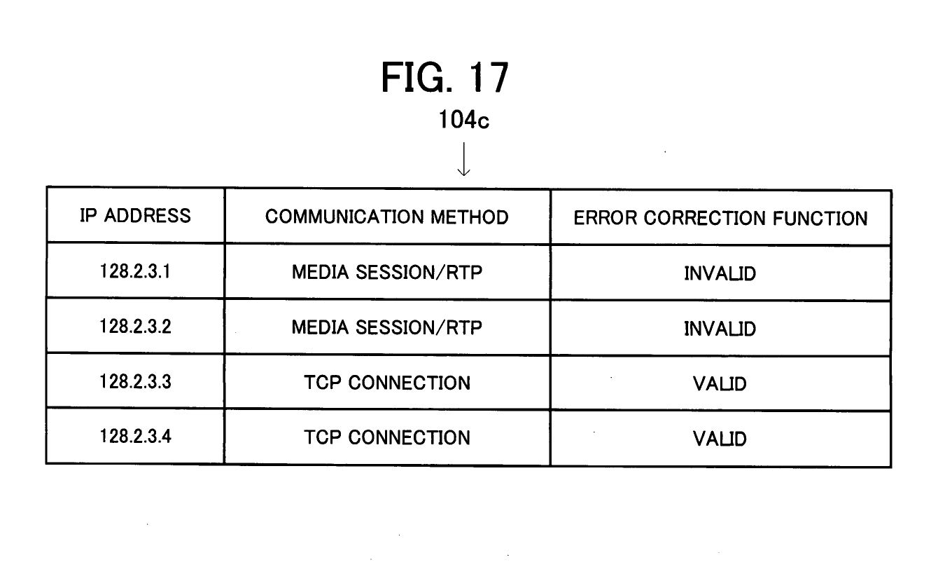

Next, another example of the second embodiment will be described. Instead of the communication method determination table 104a, the facsimile MFP 101 of another example of the second embodiment includes a communication method determination table shown in FIG. 16 or FIG. 17. In accordance with the communication method determination table shown in FIG. 16 or FIG. 17, the facsimile MFP 101 carries out the selection processing of S101 and the determination processing of S103. Further, an application of the communication method determination table shown in FIG. 17 is based on a condition that a negative determination is made at S84 and the processing operation of S86 is not carried out.

A communication method determination table 104b shown in FIG. 16 stores setting information regarding whether to carry out the data communication in the media session or whether to carry out the data communication directly on the TCP connection instead of the media session and setting information regarding whether or not to execute the error correction processing by associating with each destination port number. In the selection processing of S101, the transmitter 101A having the communication method determination table 104b selects whether to carry out the data communication in the media session or whether to carry out the data communication directly on the TCP connection instead of in the media session, in accordance with the setting of the communication method determination table 104b associated with the destination port number acquired at S83. For example, as shown in FIG. 16, in case the destination port number is “4004” or “4006”, since the communication method is set as “MEDIA SESSION/RTP”, a selection is made to carry out the data communication by the RTP in the media session. In case the destination port number is “4008” or “4010”, since the communication method is set as a “TCP CONNECTION”, a selection is made to carry out the data communication directly on the TCP connection instead of in the media session. In the determination processing of S103, a determination is carried out as to whether or not to execute the error correction processing in accordance with the setting of the communication method determination table 104b associated with the destination port number acquired at S83. For example, as shown in FIG. 16, in case the destination port number is “4004” or “4006”, since the error correction function is set invalid, a determination is made not to execute the error correction processing. In case the destination port number is “4008” or “4010”, since the error correction function is set valid, a determination is made to execute the error correction processing.

A communication method determination table 104c shown in FIG. 17 stores setting information regarding whether to carry out the data communication in the media session or whether to carry out the data communication directly on the TCP connection instead of in the media session and setting information regarding whether or not to execute the error correction processing by associating with each destination IP address. In the selection processing of S101, the transmitter 101A having the communication method determination table 104c determines whether to carry out the data communication in the media session or whether to carry out the data communication directly on the TCP connection instead of in the media session, in accordance with the setting of the communication method determination table 104c associated with the destination IP address acquired at S83. For example, as shown in FIG. 17, in case the destination IP address is “128.2.3.1” or “128.2.3.2”, since the communication method is set as “MEDIA SESSION/RTP”, a determination is made to carry out the data communication by the RTP in the media session. In case the destination IP address is “128.2.3.3” or “128.2.3.4”, since the communication method is set as a “TCP CONNECTION”, a determination is made to carry out the data communication directly on the TCP connection instead of in the media session. In the determination processing of S103, a determination is carried out as to whether or not to execute the error correction processing in accordance with the setting of the communication method determination table 104c associated with the destination IP address acquired at S83. For example, as shown in FIG. 17, in case the destination IP address is “128.2.3.1” or “128.2.3.2”, since the error correction function is set invalid, a determination is made not to execute the error correction processing. In case the destination IP address is “128.2.3.3” or “128.2.3.4”, since the error correction function is set valid, a determination is made to execute the error correction processing.

Further, in the selection processing of S101 and the determination processing of S103, a determination of whether or not to execute the error correction processing can be carried out in accordance with information relating to the media session other that the type of the communication data, the destination IP address and the destination port number described above.

In the second embodiment and the other examples of the second embodiment, an example of the facsimile MFP 101 has been described. The above-described processing operation of the facsimile MFP 101 can be carried out also by a general-purpose computer such as a PC. That is, a program for carrying out the above-described processing operation can be embedded in facsimile communication software or the like for the PC and by executing the program, the above-described communication processing operation can be carried out.

1. A communication device, comprising:
means for acquiring various pieces of information of a destination in an initiation call control session by a call control protocol;
means for determining a data transmission protocol for transmitting transmission data in accordance with the acquired various pieces of information and/or a type of the transmission data; and
means for transmitting the transmission data to the destination by the data transmission protocol determined by the means for determining.

2. The communication device according to claim 1, wherein the means for transmitting comprises:
a first communicating means for carrying out a data transmission in a media session established by the call control protocol; and
a second communicating means for executing a termination call control session without carrying out the data transmission after the various pieces of information of the destination are acquired in the initiation call control session by the call control protocol, establishing a Transmission Control Protocol (TCP) connection with the destination by designating location information included in the acquired various pieces of information of the destination and carrying out the data transmission on the established TCP connection.

3. The communication device according to claim 1, wherein the means for transmitting comprises:
a first communicating means for carrying out a data transmission while executing an error correction in a media session established by the call control protocol;
a second communicating means for carrying out a data transmission without executing the error correction in the media session established by the call control protocol; and
a third communicating means for executing a termination call control session without carrying out the data transmission after the various pieces of information of the destination are acquired in the initiation call control session by the call control protocol, establishing a Transmission Control Protocol (TCP) connection with the destination by designating location information included in the acquired various pieces of information of the destination and carrying out the data transmission on the established TCP connection.

4. A communication device, comprising:
means for carrying out a data communication with a destination in a media session established by a call control protocol;
means for determining whether or not to execute an error correction processing for the data communication in accordance with information relating to the established media session; and
means for controlling to carry out the data communication while executing the error correction processing in case the means for determining determines to execute the error correction processing, and to carry out the data communication without executing the error correction processing in case the means for determining determines not to execute the error correction processing.

5. The communication device according to claim 4, wherein the error correction processing is executed by an error correction protocol which is not involved in a communication protocol used in the media session and a content of the data exchanged by the communication protocol.

6. The communication device according to claim 4, wherein the error correction processing is executed by a Transmission Control Protocol/Internet Protocol (TCP/IP).

7. The communication device according to claim 4, wherein the error correction processing is executed in a layer higher than a User Datagram Protocol/Internet Protocol (UDP/IP).

8. The communication device according to claim 4, wherein the means for determining determines whether or not to execute the error correction processing in accordance with a type of data transmitted and received in the media session.

9. The communication device according to claim 4, wherein the means for determining determines whether or not to execute the error correction processing in accordance with a port number.

10. The communication device according to claim 4, wherein the means for determining determines whether or not to execute the error correction processing in accordance with an Internet Protocol (IP) address.

11. A communication device, comprising:
a first communicating means for carrying out a data communication with a destination in a media session established by a call control protocol;
a second communicating means for executing a termination call control session without executing the data communication after the various pieces of information of the destination are acquired in an initiation call control session by the call control protocol, establishing a Transmission Control Protocol (TCP) connection with the destination by designating location information included in the acquired various pieces of information of the destination and carrying out the data communication on the established TCP connection; and
means for selecting one of the first communicating means and the second communicating means in accordance with prescribed information when starting the data communication and carrying out the data communication by the selected communicating means.

12. The communication device according to claim 11, wherein the prescribed information is the various pieces of information of the destination acquired in the initiation call control session.

13. The communication device according to claim 11, wherein the prescribed information is a port number.

14. The communication device according to claim 11, wherein the prescribed information is an Internet Protocol (IP) address.

15. A communication method, comprising the steps of:
acquiring various pieces of information of a destination in an initiation call control session by a call control protocol;
determining a data transmission protocol for transmitting transmission data in accordance with the acquired various pieces of information and/or a type of the transmission data; and
transmitting data to the destination by the determined data transmission protocol.

16. The communication method according to claim 15, wherein the transmitting step transmits the data by one of the steps of:
carrying out a data transmission in a media session established by the call control protocol; and
executing a termination call control session without carrying out the data transmission after the various pieces of information of the destination are acquired in the initiation call control session by the call control protocol, establishing a Transmission Control Protocol (TCP) connection with the destination by designating location information included in the acquired various pieces of information of the destination and carrying out the data transmission on the established TCP connection.

17. The communication method according to claim 15, wherein the transmitting step transmits the data by one of the steps of:
carrying out a data transmission while executing an error correction in a media session established by the call control protocol;
carrying out the data transmission without executing the error correction in the media session established by the call control protocol; and
executing a termination call control session without carrying out the data transmission after the various pieces of information of the destination are acquired in the initiation call control session by the call control protocol, establishing a Transmission Control Protocol (TCP) connection with the destination by designating location information included in the acquired various pieces of information of the destination and carrying out the data transmission on the established TCP connection.
